(19) United States
(12) Patent Application Publication
(10) Pub. No.: US 2013/0238399 A1
(43) Pub. Date: Sep. 12, 2013

(54) Computer-Implemented Systems and Methods for Scenario Analysis

(71) Applicant: SAS INSTITUTE INC., Cary, NC (US)

(72) Inventors: Michael Ryan Chipley, Raleigh, NC (US); Michael J. Leonard, Cary, NC (US); Philip Lodge Holman, Raleigh, NC (US); Jerzy Michal Brzezicki, Cary, NC (US); Karl Moss, Raleigh, NC (US); Dinesh P. Apte, Pune (IN)

(73) Assignee: SAS Institute Inc., Cary, NC (US)

(21) Appl. No.: 13/772,200

(22) Filed: Feb. 20, 2013

Related U.S. Application Data
(63) Continuation of application No. 12/611,497, filed on Nov. 3, 2009.

(51) Int. Cl. G06Q 10/06

(52) U.S. Cl. CPC G06Q 10/06375
USPC 705/7.37

(57) ABSTRACT

Computer-implemented systems and methods are provided for implementing a scenario analysis manager that performs multiple scenarios based upon time series data that is representative of transactional data are provided. A system and method provides candidate predictive models for a first scenario for selection where the set of candidate predictive models includes an identification of variables associated with a model. Model selection data is received from a scenario analysis manager where a selected model is configured to predict a future value of a first variable based on values of a second variable. Time series data is received representative of past transaction activity of the first variable and the second variable, and data representative of a future value of the second variable is also received. The future value of the first variable is determined using the selected model, the time-series data and the future value of the second variable.

### CROSS-REFERENCE TO RELATED APPLICATIONS

This application is a continuation application of U.S. patent application Ser. No. 12/611,497 filed Nov. 3, 2009, entitled “Computer-Implemented Systems and Methods for Scenario Analysis,” the entirety of which is herein incorporated by reference.

### FIELD

The technology described herein relates generally to data modeling and more specifically to computer-implemented scenario analysis.

### BACKGROUND

Data analysts are often charged with the task of predicting what effect a given future event might have on an organization. Similarly, they may also seek to determine what events need to happen between now and a future time for an organization to reach a specified goal. They may be further tasked to discover how certain contributing factors can be manipulated to maximize a metric for an organization, such as sales or inventory turnover or profit. Statistical data models may be used as tools in aiding data analysts in making these and other determinations. However, the selection of data models to make these determinations is difficult, especially when ensuring the best probability of a successful prediction.

### SUMMARY

In accordance with the teachings provided herein, computer-implemented systems and methods are provided for implementing a scenario analysis manager that performs multiple scenarios based upon time series data that is representative of transactional data. For example, a system and method provides a set of candidate predictive models for a first scenario for selection where the set of candidate predictive models includes an identification of which variables are associated with a model. Model selection data is received from a scenario analysis manager where a selected model is configured to predict a future value of a first variable based at least in part on values of a second variable. Time series data is received representative of past transaction activity of the first variable and the second variable, and data representative of a future value of the second variable is also received. The future value of the first variable is determined using the selected model, the time-series data and the future value of the second variable.

As another example, a system and method is provided for storing data for access by a scenario analysis management application program that performs multiple scenarios within a project based upon time series data that is representative of transactional data. A memory may include one or more data structures stored in the memory that include information used by the application program that includes project records containing one-to-many scenario links between the project and one or more scenarios associated with the project. The memory may further include scenario records containing one-to-one model links between a scenario and a model associated with the scenario and model records containing one-to-many predictive variable links between a model and one or more variables associated with the model. The memory may also include past value records containing time series data representative of transaction activity involving a first variable and a second variable, where the first variable and the second variable are associated with a model through the predictive variable links. Future value records identifying one or more future values of the second variable may also be included as well as a scenario value record for storage of a future value of the first variable determined using a model identified by a scenario record that calculates the scenario value using past record values and a future value record. The scenario analysis manager may compute the future value of the first variable for each scenario in a project, each scenario being identified by a scenario link, the computing using a model associated with the scenario, the model being identified by a model link, where the model receives as inputs past values of the first variable and the second variable and the future value of the second variable to compute the future value of the first variable. The scenario analysis manager may display the future value of the first variable for multiple scenarios simultaneously.

As another example, a computer display device is provided for generating a scenario analysis manager graphical user interface for displaying a future value of a first variable for multiple scenarios simultaneously may include a project definition display region for defining one or more scenarios associated with a project and a model selection region for providing a set of candidate models for selection and for receiving selection data, where a selected model is configured to predict a future value of a first variable based at least in part on past values of a second variable and a model selection region that identifies one or more independent and dependent variables associated with a model. The graphical user interface may further include a future value definition region for receiving data defining one or more future values of the second variable and a scenario display region for providing a graphical depiction of a calculated future value of the first variable determined using the selected model, past values of the first variable, past values of the second variable, and the one or more future values of the second variable, where the scenario display region displays the future value of the first variable for multiple scenarios simultaneously.

As a further example, a computer-implemented system method is provided for implementing a scenario analysis manager that performs multiple scenarios based upon time series data that is representative of transactional data and displays results of the multiple scenarios simultaneously may include providing a set of candidate predictive models for a first scenario for selection where the set of candidate predictive models includes an identification of which variables are associated with a model. Model selection data can be received where a selected model is configured to predict a future value of a first variable based at least in part on values of a second variable and receiving time-series data from a computer-readable memory representative of past transaction activity of the first variable and the second variable. Data representative of a future value of the second variable may be received and the future value of the first variable may be determined using the selected model, the time-series data, and the future value of the second variable. The future value of the first variable for the first scenario may be stored in a computer-readable memory, and the future value of the first variable may be displayed simultaneously with a future value of a second scenario.

As an additional example, a computer-implemented system and method is provided for implementing a scenario analysis manager that performs multiple scenarios based upon time series data that is representative of transactional data and displays results of the multiple scenarios simultaneously may include a processing system including at least one data processor and a computer-readable memory coupled to the processing system. Software instructions may be configured to execute steps that include providing a set of candidate predictive models for a first scenario for selection where the set of candidate predictive models include an identification of which variables are associated with a model and receiving model selection data where a selected model is configured to predict a future value of a first variable based at least in part on values of a second variable. The software instructions may be further configured to receive time-series data from a computer-readable memory representative of past transaction activity of the first variable and the second variable and receive data representative of a future value of the second variable. The software instructions may also be configured to determine the future value of the first variable using the selected model, the time-series data, and the future value of the second variable and store the future value of the first variable for the first scenario in a computer-readable memory. The future value of the first variable can be displayed simultaneously with a future value of a second scenario.

### BRIEF DESCRIPTION OF THE DRAWINGS

FIG. 1 depicts a computer-implemented environment wherein users can interact with a scenario analysis manager hosted on one or more servers through a network.

FIG. 2 is a block diagram depicting an example project managed by a scenario analysis manager.

FIG. 3 is a block diagram depicting relationships between scenarios, models, and input variables managed by a scenario analysis manager.

FIG. 4 is a block diagram depicting data records managed by a scenario analysis manager.

FIG. 5 is a block diagram depicting example data structures managed by a scenario analysis manager.

FIG. 6 is a screenshot depicting a graphical user interface for providing input data defining a new scenario for incorporation into a project.

FIG. 7 is a screenshot depicting a graphical user interface for providing expanded details of models available for selection in a scenario.

FIG. 8 is a screenshot depicting a graphical interface for identifying desired manipulations for a variable in a scenario.

FIG. 9 is a screenshot depicting a graphical user interface for providing details of models associated with a project.

FIGS. 10A and 10B are data tables depicting example data associated with a plurality of scenarios within a project.

FIG. 11 is a screenshot depicting a graphical user interface for editing a model associated with a scenario.

FIGS. 12A and 12B are screenshots depicting a graphical user interface for displaying determinations of future values for one or more scenarios.

FIG. 13 is a screenshot depicting a graphical user interface for displaying a comparison of future values associated with multiple scenarios simultaneously.

FIGS. 14A and 14B are screenshots depicting a graphical user interface for displaying one or more scenarios in comparison with a prior forecast.

FIG. 15 is a flow diagram depicting a computer-implemented method of implementing a scenario analysis manager that performs multiple scenarios based upon time series data that is representative of transactional data and displays results of the multiple scenarios simultaneously.

FIGS. 16A, 16B, and 16C depict example processing systems for use in implementing a scenario analysis manager.

### DETAILED DESCRIPTION

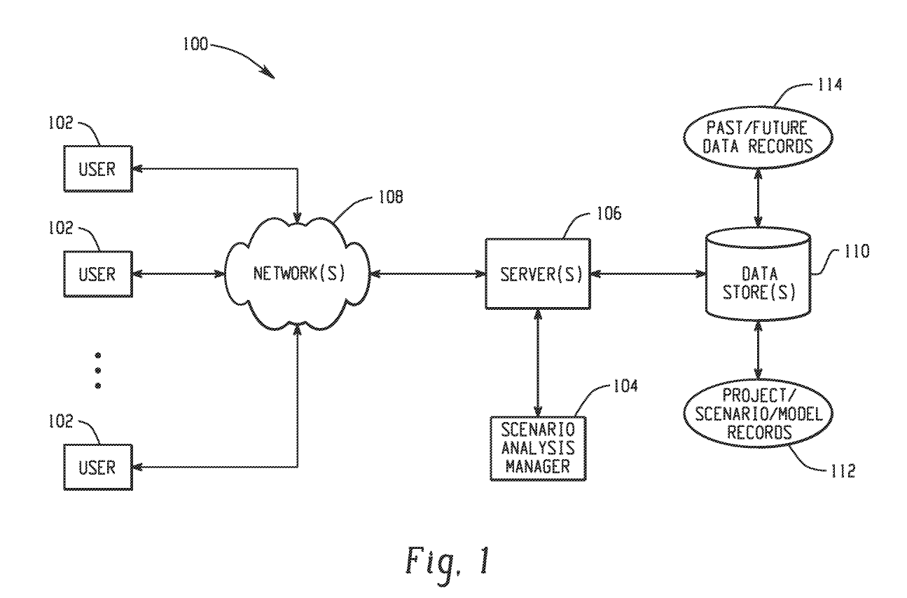

FIG. 1 depicts at 100 a computer-implemented environment wherein users 102 can interact with a scenario analysis manager 104 hosted on one or more servers 106 through a network 108. The system 104 contains software operations or routines for implementing a scenario analysis manager that performs multiple scenarios based upon time series data. The users 102 can interact with the system 104 through a number of ways, such as over one or more networks 108. One or more servers 106 accessible through the network(s) 108 can host the scenario analysis manager 104. It should be understood that the scenario analysis manager 104 could also be provided on a stand-alone computer for access by a user.

The scenario analysis manager 104 computes one or more future values for a first variable based on past values of the first variable and a second variable as well as proposed future values of the second variable. The scenario analysis manager 104 further enables the creation and simultaneous comparison of multiple scenarios which may vary in the data model used, input variables considered, past time-series data considered, future predicted value inputs, as well as many other factors. For example, a user 102 may want to hypothesize the effect on weekly profits for a region of retail stores that a manipulation on product pricing may make. After selection of a model, past time-series data relating price and profits for the region of retail stores is provided to the model for training such as via linear regression or other statistical processes. Data is then input as to one or more future values of product price. For example, one desired scenario may raise prices 10%, one scenario may lower prices 15%, one scenario may lower prices by 5% each week for 3 weeks, and one scenario may keep prices the same. The scenario analysis manager receives this future hypothetical data for the second price variable and determines predicted values for the first regional profit variable for each of the desired scenarios. Each of the predicted values for each of the scenarios may be presented for the three weeks in the form of a line graph or other type of graph. A user 102 may select one of the scenario predictions that the user thinks is most likely to match future results and may persist that prediction as the forecast to be used in other calculations. For example, a user 102 may decide to lower prices 15% and may, thus, select the scenario prediction associated with the 15% price reduction as the forecast for profits for the associated region.

A scenario provides a determination as to how a generated forecast may change when one manipulates the future values of one or more independent or dependent variables. A scenario analysis manager may be configured to perform one or more of a variety of functions related to a given scenario. In a first mode of operation, as described above, a prediction of a future value of a first dependent variable is generated by the scenario analysis manager based on past values of the first dependent variable, past values of one or more independent variables, and one or more predicted values of the one or more independent variables. In a second, goal-seeking, mode of operation, a determination of future values for one or more first dependent variables is determined to reach a desired value for an independent variable. For example, in a goal-seeking operation, the scenario analysis manager may determine a future value of the independent price variable that will yield a desired future dependent variable, profit, value based on past values of the price and profit variables and the desired future value of the profit dependent variable. The scenario analysis manager may also perform in an optimization mode where one or more first future variable values are determined to maximize or minimize a second future value. For example, a scenario analysis manager may determine future values of independent variables price and advertising expenditures to maximize the profit dependent variable.

A scenario analysis manager may also be utilized in the testing of models using hold-out data. Hold-out data consists of a set of past data that is not used in training a model but is instead used in testing the accuracy of a model. Thus, a predicted value for a first variable may be determined by the scenario analysis manager based on a first set of past data for the first variable and a second variable as well as a second set of hold-out past data for the second variable, where the second set of hold-out past data is subsequent to the first set of past data. Thus, the known, hold-out data for the second variable is treated as a “future” value of the second variable. The scenario analysis manager then determines a predicted “future” value of the first variable based on the “future” hold-out data for the second variable. The predicted “future” value of the first variable determined by the scenario analysis manager may then be compared to the actual hold-out data for the first variable to determine the accuracy of the data model compared to real-life results.

With reference back to FIG. 1, the scenario analysis manager 104 can be an integrated web-based analysis tool that provides users flexibility and functionality for performing scenario analyses or can be a wholly automated system. One or more data stores 110 can store the data to be analyzed by the system 104 as well as any intermediate or final data generated by the system 104. For example, data store(s) 110 can store project definition data 112 that describes relationships between a project, scenarios within the project, and a model associated with a scenario. The one or more data stores 110 may also contain time series data 114 representative of past values of one or more variables and may also contain predictions of future values of the one or more variables. Examples of data store(s) 110 can include relational database management systems (RDBMS), a multi-dimensional database (MDDB), such as an Online Analytical Processing (OLAP) database, etc.

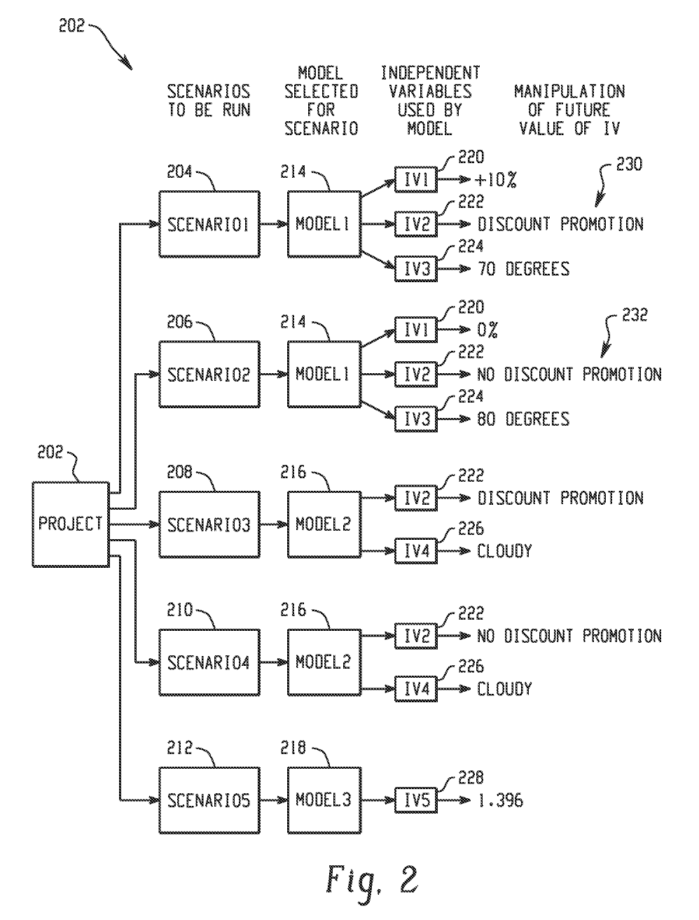

FIG. 2 is a block diagram depicting at 200 an example project 202 managed by a scenario analysis manager. The project 202 includes a number of scenarios testing the effects of different manipulations on amusement park attendance. Five scenarios 204, 206, 208, 210, 212 to be executed are associated with the project 202. Each scenario has a model associated with the scenario. In the example of FIG. 2, model 1 214 is associated with scenario 1 204 and scenario 2 206, model 2 is associated with scenario 3 208 and scenario 4 210 and model 3 218 is associated with scenario 5 212. One or more independent variables (also referred to as “predictive variables” or “input variables”) are associated with each model. Independent variable (IV) 1 220 related to advertising dollars spent, IV2 222 related to a price discount promotion, and IV3 224 related to the temperature are associated with model 1 214; IV 2 222 and IV 4 226 related to the weather are associated with model 2 216; and IV5 228 related to an exchange rate of the dollar is associated with model 3 218. As shown in FIG. 2, independent variables associated with the models may overlap between models at varying levels (i.e., some, all, or not at all). A project 202 also includes manipulations for some or all of the independent variables for each scenario. For example, in scenario 1 204, advertising dollars spent are increased 10%, a discount program is implemented, and the projected temperature is set to 70 degrees, as shown at 230. In scenario 2 206, advertising expenditures remain unchanged, no discount program is implemented, and the projected temperature is set to 80 degrees, as shown at 232. After receipt of inputs defining a project and manipulations to be made for each scenario in the project, a scenario analysis manager determines predicted future values of one or more variables based on the desired manipulations in the defined scenarios and may display those future values to a user.

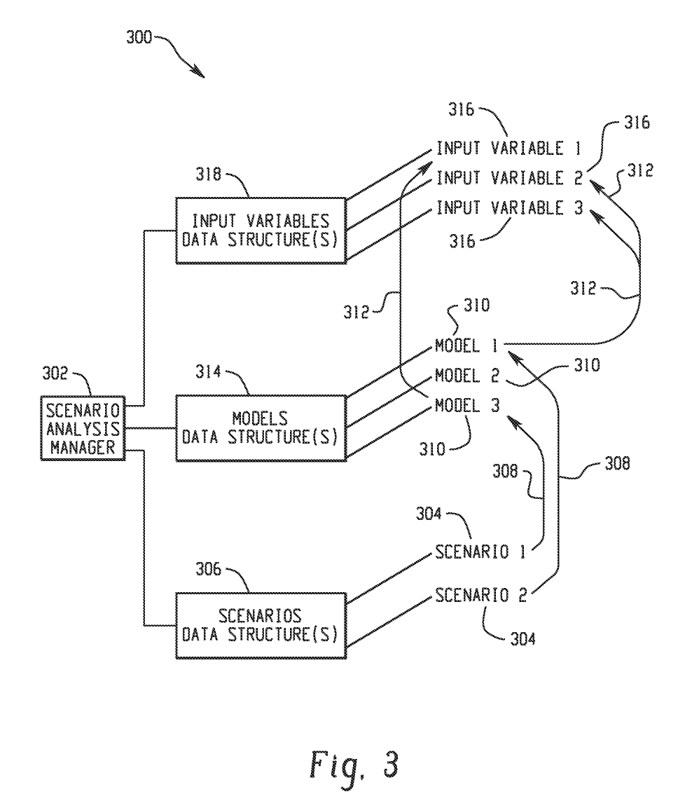

The scenario analysis manager provides for quick and easy selection of one or more models for a project, selection of input data and future scenario data for utilization by the selected models, and execution of efficient and accurate scenario determinations by managing a number of data structures describing the state of a project. FIG. 3 is a block diagram depicting at 300 relationships among scenarios, models, and input variables which are managed by a scenario analysis manager 302. A scenario analysis manager 302 manages one or more scenarios 304 via a scenarios data structure 306. The scenarios data structure 306 contains one or more model links 308 that identify which models 310 are associated with which scenarios. For example, model links 308 contained within the scenarios data structure may provide one-to-one links identifying a model associated with each scenario. The scenario analysis manager 302 may also manage input variable links 312 contained within a models data structure 314. For example, a model record within the models data structure 314 may include one-to-many input variable links 312 identifying one or more predictive input variables 316 associated with each model 310.

Each of the data structures 306, 314, 318 may also contain other information about certain entities at their level. For example, the scenario data structure 306 may include data on each scenario 304 such as a scenario name, a scenario date of creation, a scenario description, as well as other data. The models data structure 314 may contain data on each model 310 such as a model name, a model date of creation, a model description, a model input data type, a model output data type, as well as other data. The input variables data structure 318 may contain data on each input variable 316 such as an input variable name, an input variable type, and input variable description, as well as other data.

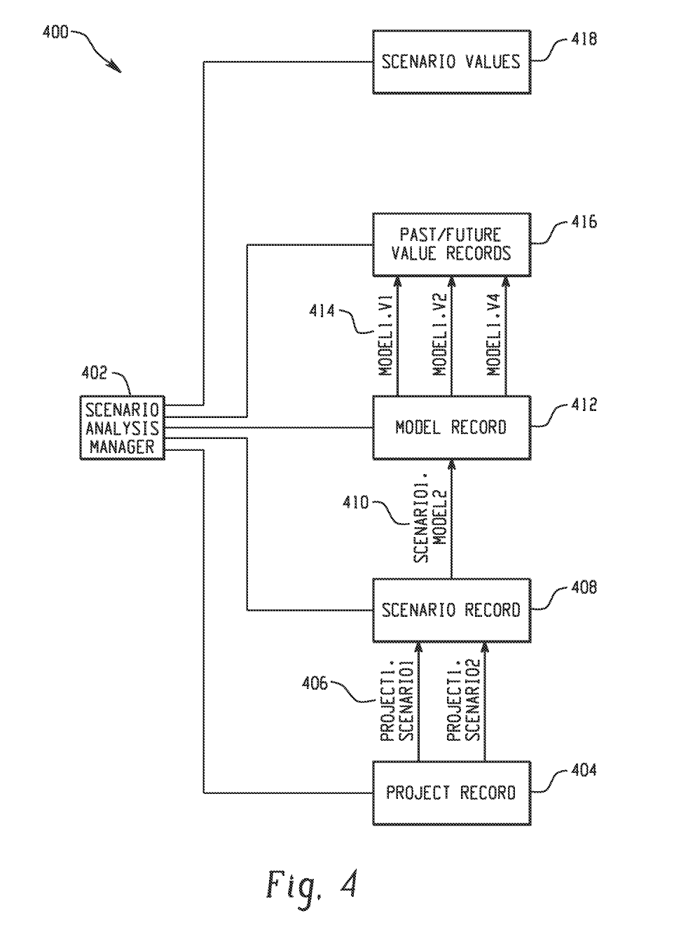

FIG. 4 is a block diagram depicting at 400 data records managed by a scenario analysis manager 402. A scenario analysis manager 402 manages one or more project records 404, each project containing one or more scenarios. A project record contains one-to-many scenario links 406 between a project identified by the project record 404 and one or more scenarios associated with the project. The scenario analysis manager 402 also controls one or more scenario records 408.

Each scenario record 408 identifies a model associated with the scenario via a model link 410 contained in the scenario record 408. The scenario analysis manager 402 further manages one or more model records 412. A model record contains one-to-many input variable links 414 between a model identified by the model record 412 and one or more variables associated with the model. The scenario analysis manager 402 further administers a plurality of past/future value records 416. The past/future records may, for example, contain time series data associated with the variables identified by the input variable links 414 associated with a model record 412. The past/future value records may include past and/or predicted future values of dependent and/or independent variables referenced by a model record 412. The scenario analysis manager 402 may also control scenario values 418 that contain future values determined by the scenario analysis manager 402 in running a scenario analysis identified by the project records 404, scenario records 408, model records 412, and past/future value records 416.

FIG. 5 is a block diagram depicting at 500 example data structures managed by a scenario analysis manager 502. In managing one or more projects, a scenario analysis manager 502 may control several link-tables identifying associations among projects, scenarios, models, and variables. For example, the scenario analysis manager 502 may manage a project-scenario links table 504. The project-scenario links table 504 contains scenario links 506 between projects and one or more scenarios associated with each project by project ID 508 and scenario ID 510. The scenario analysis manager 502 may further control a scenario-model links table 512. The scenario-model links table 512 contains model links 514 between a scenario and a model associated with the scenario by scenario ID 510 and model ID 516. The scenario analysis manager 502 may further manage a model-predictive variable (PV) links table 518. The model-PV table 518 contains predictive variable links 520 between a model and predictive variables associated with the model by model ID 516 and PV ID 522.

The scenario analysis manager 502 may further manage descriptive tables and records that provide information describing entities at each level (i.e., project level, scenario level, model level, variable level). The descriptive information may be incorporated into the links records described above or may be broken into separate data structures as shown in FIG. 5. For example, a project table 524 may include records identifying a project name, project type, and other project information that it indexed by project ID 508. A scenario table 526 may include records identifying a scenario name, a scenario type, and other scenario information that it indexed by scenario ID 510. A model table 528 may include records identifying a model name, a model type, and other model information that it indexed by model ID 516. A predictive variable table 530 may include records identifying a predictive variable name, a predictive variable data type, and other predictive variable information that it indexed by PV ID 522.

The scenario analysis manager 502 may also manage desired manipulations to future values of the predictive variables. For example, as described above, one scenario may reduce a price variable by 10% per week for three weeks to examine the effect on regional profits. Such a manipulation may be stored in a scenario-manipulation table 532 that identifies one or more future manipulations to be made to a predictive variable over one or more future time periods. A scenario-manipulation table 532 may store the desired manipulation 534 (e.g., set a predictive variable, temperature, to 80 degrees Fahrenheit for future time period number 1, in predicting amusement park attendance) by scenario ID 510 and predictive variable ID 522. Records of the scenario-manipulation index may also be indexed by a manipulation index (not shown) which may be linked from the scenario-model links table 512 or other location.

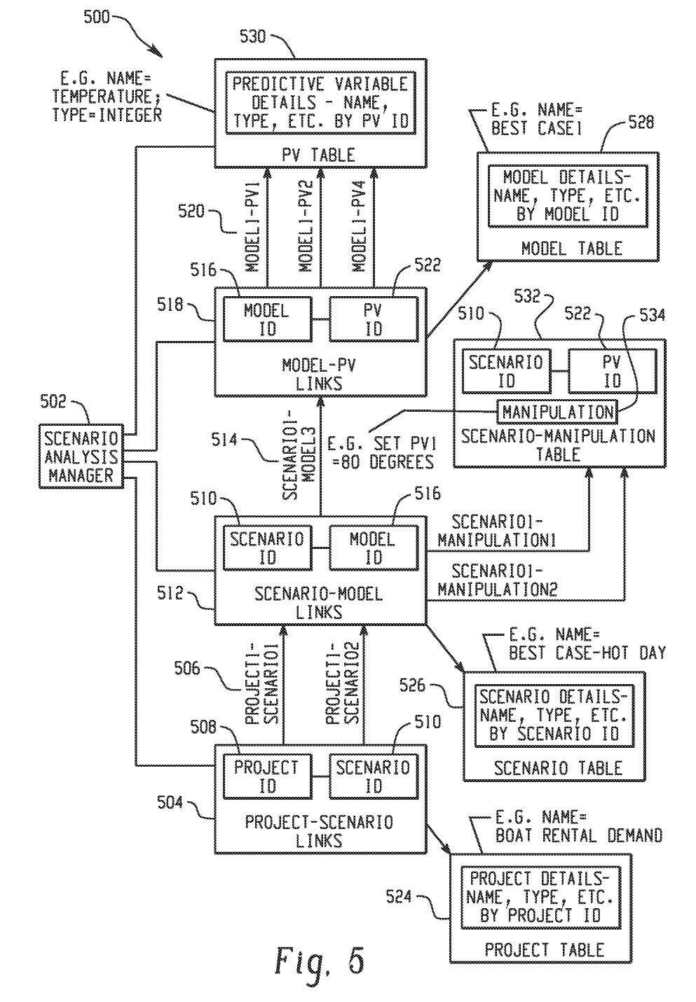

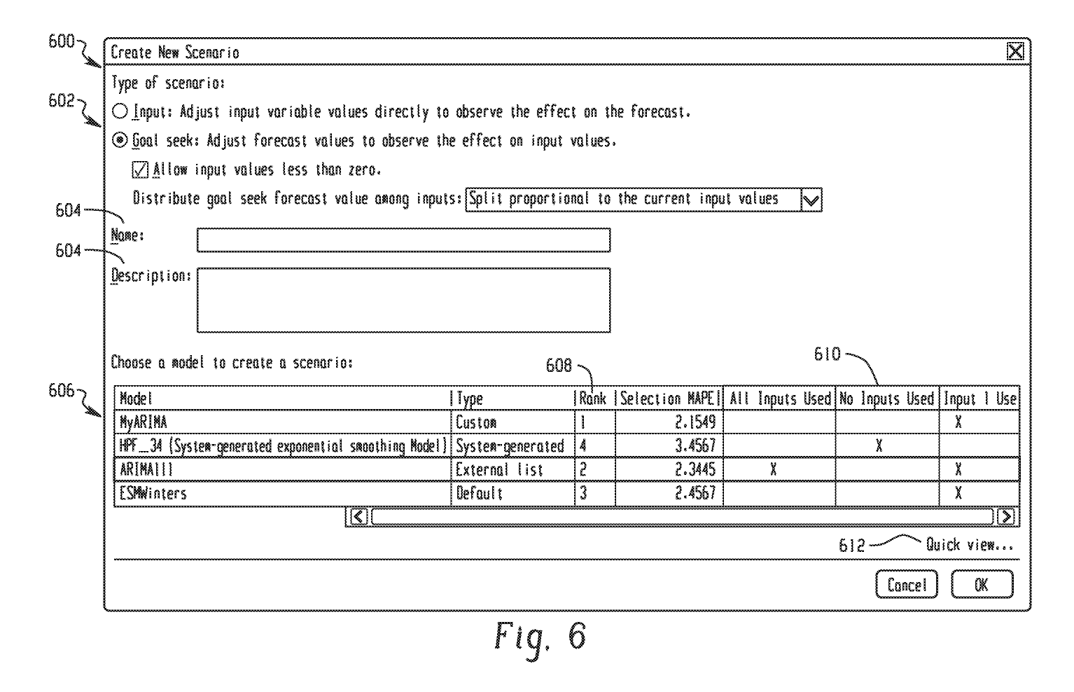

FIG. 6 is a screenshot depicting at 600 a graphical user interface for providing input data defining a new scenario for incorporation into a project. A user is provided a scenario type prompt 602 offering options on the type of scenario to be generated. For example, in an input type scenario, future values of one or more independent variables are manipulated to determine predicted future values of one or more dependent variables. In a goal seeking scenario, future values of one or more dependent variables are manipulated to determine predicted values of independent variables that would generate in the identified dependent variable result. A new scenario interface 600 may also include input mechanisms 604 for entering descriptive data about the scenario such as a scenario name and a text description of the scenario.

Further, a new scenario interface 600 includes a model selection interface area 606 for displaying models and associated information about the models and for accepting selection of a model to associate with the scenario. The model selection interface area 606 provides data about a set of models available for selection for a scenario. Data provided may include a name and model type. The models may be ranked, as shown at 608, based on a quality metric. The quality metric may be based on one or more of a number of factors including prior user recommendations, hold-out data testing accuracy, percentage of times data from the model is persisted as a permanent forecast, as well as others. The model selection interface area 606 also may offer data regarding variables associated with each model, as shown at 610. The associated variables data 610 aides a user in selecting a model by identifying the variables that may be predicted by a model as well as to which variables a model is sensitive. Thus, if one wishes to analyze the effect of temperature on amusement park attendance, then one would use the variables data 610 to narrow selection choices to those models that are sensitive to the temperature variable. A new scenario interface 600 may also include a quick view 612 indicator for providing expanded information related to the model selection interface area 606.

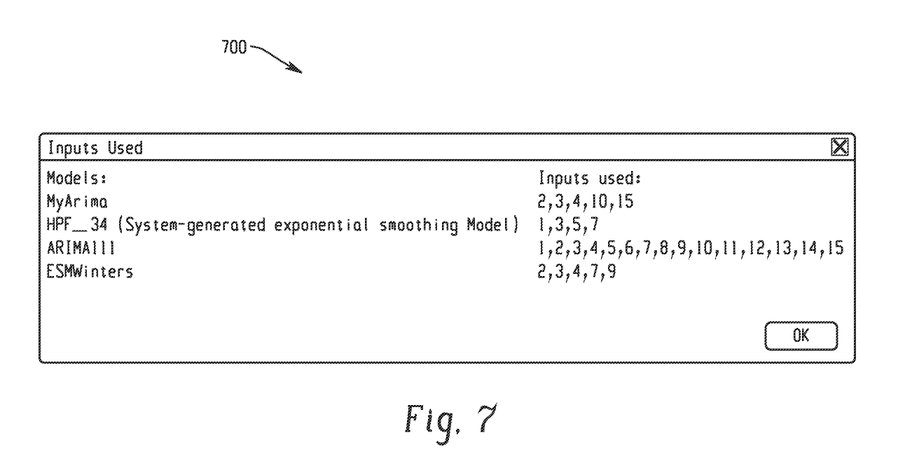

FIG. 7 is a screenshot depicting at 700 a graphical user interface for providing expanded details of models available for selection in a scenario. Such an interface may be accessed, for example, through selection of an expanded information indicator as depicted in FIG. 6 at 606. The expanded models details interface 700 displays a listing of models available for selection in a scenario as well as an exhaustive list of variables associated with each model. Such an interface enables easy identification and comparison of the variables to which a model is sensitive. Further details associated with each model may also be displayed on expanded models details interface 700 such as model description, model type, model ranking, as well as other information.

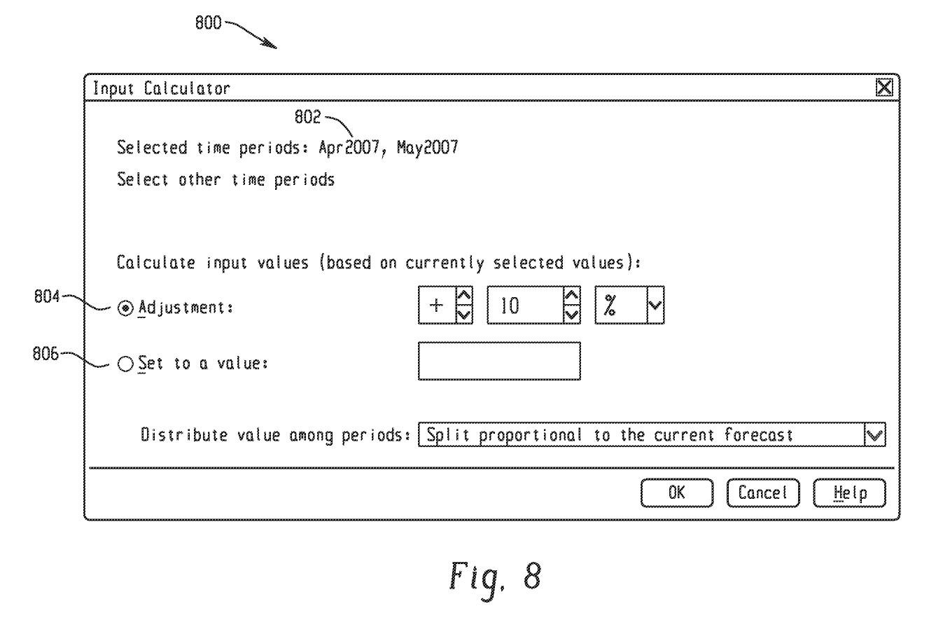

FIG. 8 is a screenshot depicting at 800 a graphical user interface for identifying desired manipulations for a variable in a scenario. For an identified set of time periods, as shown at 802, a variable's future value may be adjusted by a percentage or other measure, as shown at 804, or set to a particular value, as shown at 806. This future value data may be used by the scenario analysis manager in predicting future values of other variables. Manipulation data for variables associated with models in scenarios may be received by a scenario analysis manager by other mechanism such as a spreadsheet or a database. Manipulation data could also originate from past collected time-series data in cases where a portion of the past collected time-series data is designated as hold-out data for model accuracy analysis or other procedures.

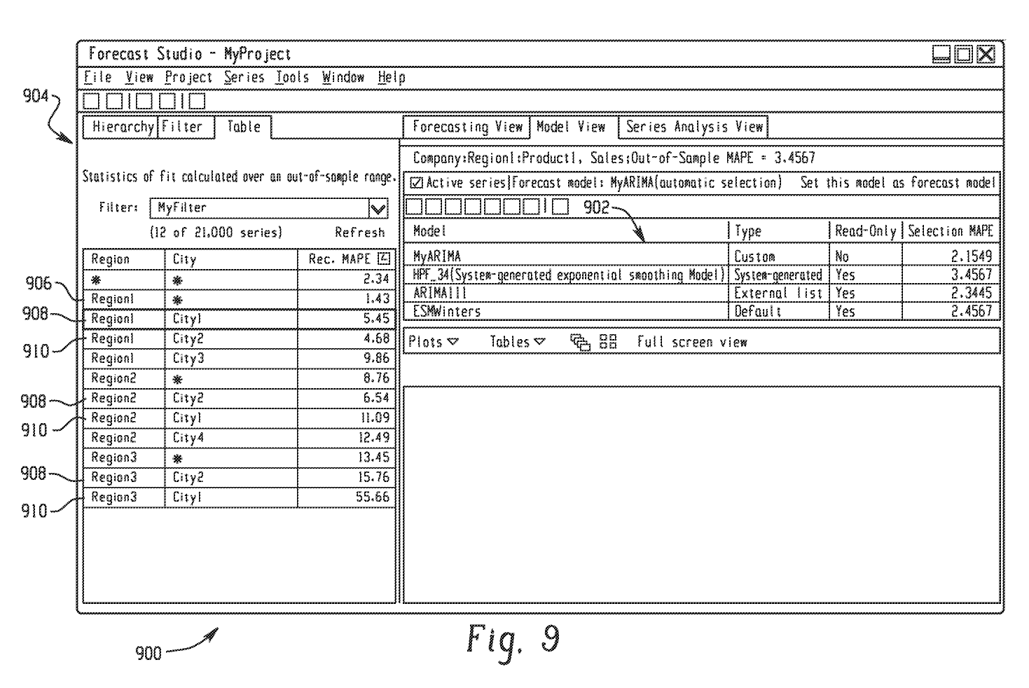

FIG. 9 is a screenshot depicting at 900 a graphical user interface for providing details of models associated with a project. The model view 900 provides a listing 902 of models that have been selected, such as via the new scenario interface of FIG. 6, as being associated with a scenario in a project. The listing provides data regarding each of the associated models that may include a model name, model type, model description, variables associated with a model, as well as other information. A model view 900 may also include a hierarchy selection region 904 for selection of a hierarchical level at which to make scenario determinations. For example, a user may select any of a number of levels and branches of the hierarchy at which to analyze, such as a top level 906 a regional level 908 or an entity at a city level 910. Hierarchies may be divided into any number of levels. For example, the hierarchy shown at 904 could be further broken down into a district level and an individual store level for providing predictions at each of these aggregate levels. Hierarchical data storage for an organization is described in U.S. patent application Ser. No. 12/412,046, entitled “Systems and Methods for Markdown Optimization when Inventory Pooling Level is above Pricing Level,” filed on Mar. 26, 2009, the entirety of which is herein incorporated by reference.

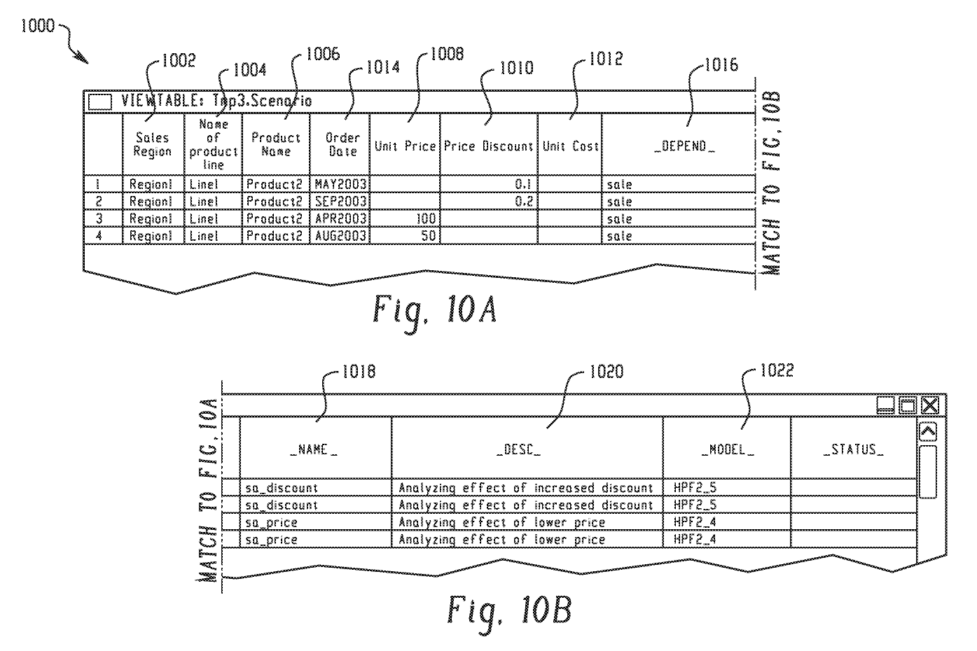

FIGS. 10A and 10B are data tables depicting at 1000 example data associated with a plurality of scenarios within a project. For each scenario listed, a hierarchical level in both the area and product line hierarchies is identified at 1002 and 1004, 1006, respectively. Columns 1008, 1010, and 1012 identify manipulations for future values of variables associated with each scenario and a time period for each of the manipulations to be applied is recited at 1014. Column 1016 identifies a dependent variable associated with a model selected for each scenario, and columns 1018, 1020, and 1022 include a model name, model description, and model identifier, respectively.

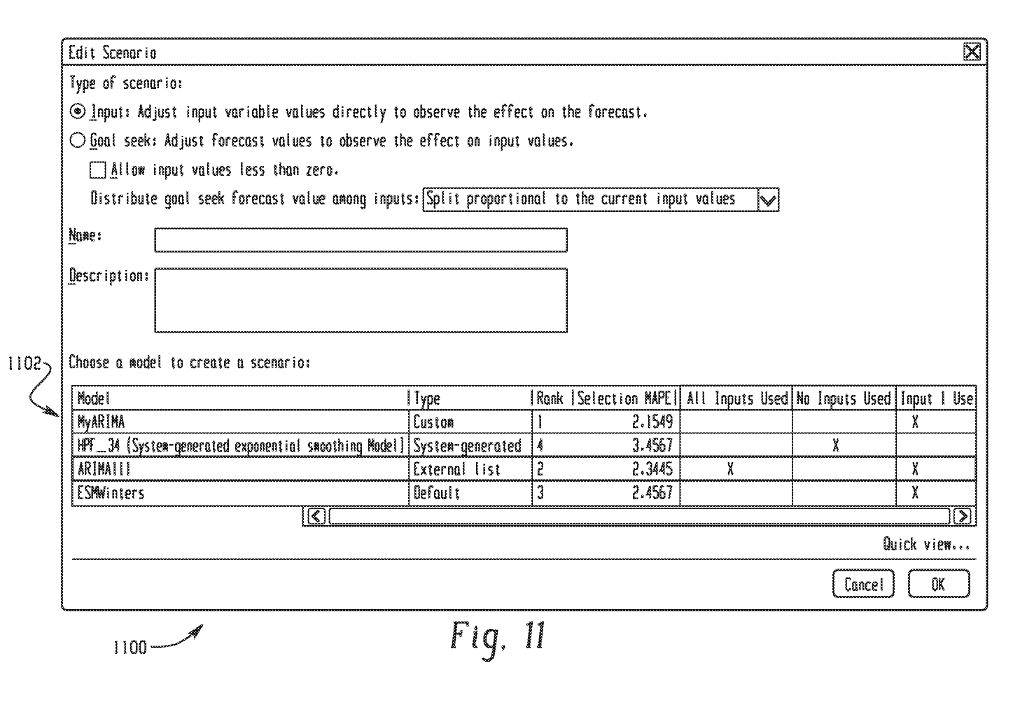

FIG. 11 is a screenshot depicting at 1100 a graphical user interface for editing a model associated with a scenario. FIG. 11 offers a similar interface to the model selection interface of FIG. 6, while offering a mechanism for a user to select a new model to associate with a scenario. Model data including a model name, type, ranking, associated variables and other model data may be provided to a user, as shown at 1102. A user may review a previous model selection and change or confirm that previous decision in addition to editing scenario details such as a scenario name and scenario description.

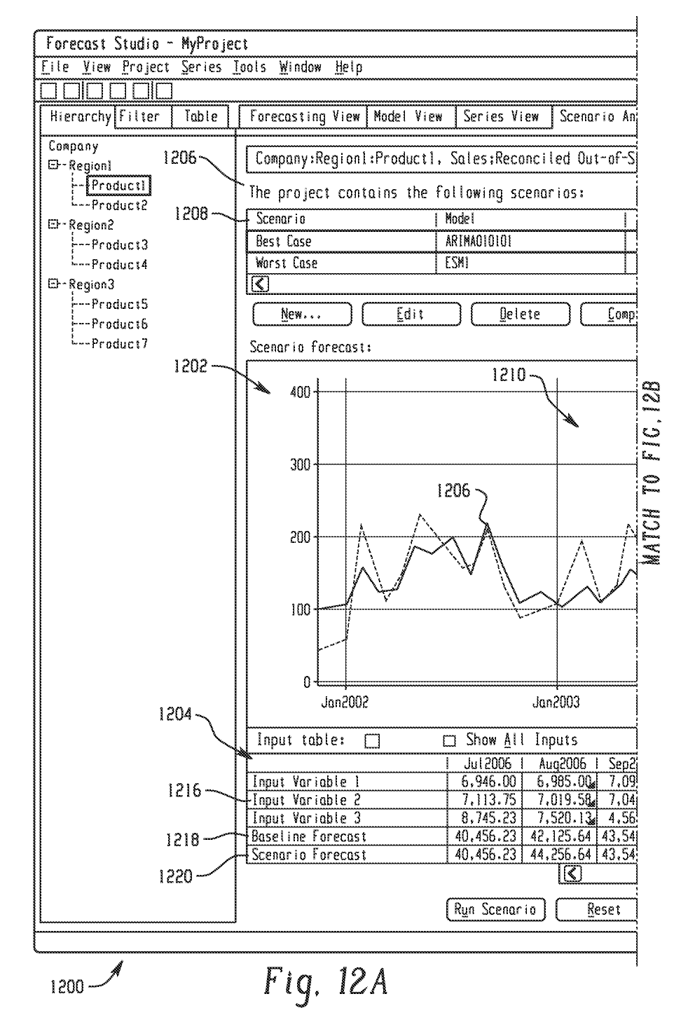

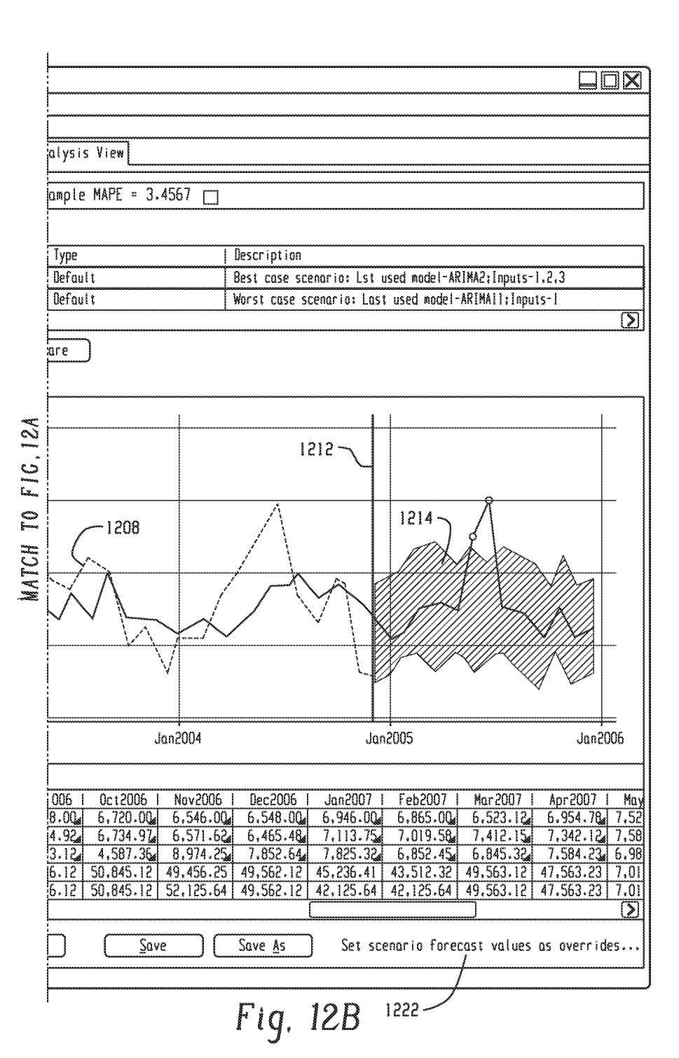

FIGS. 12A and 12B are screenshots depicting at 1200 a graphical user interface for displaying determinations of future values for one or more scenarios. Following definition of one or more scenarios, associated models, and past and future values of one or more variables, one or more future values of a variable of interest are determined by a scenario analysis manager. The one or more future values for different scenarios may be displayed simultaneously in a graph form 1202, tabular form 1204, or other form. In the example of FIG. 12A, two determined future scenario value sets are displayed, one corresponding to a scenario identified as “Best Case” 1206 and another identified as “Worst Case” 1208. The graph depiction of the two scenarios 1206, 1208 depicts past time-series data 1210 to the left of a forecast date line 1212. To the right of the forecast date line 1212, the graph depiction displays a plurality of future values for each of the two scenarios 1206, 1208. The graph depiction may also include a confidence interval 1214 associated with one of the forecasts. In the tabular data depiction 1204, each of the instructed future values of input variables 1, 2, and 3 are listed at 1216 for each period of the scenario. Also included are previously identified values of a baseline forecast 1218 for the metric being predicted by the current scenario, as well as the determined future values of the variable of interest as a scenario forecast at 1220. Should a user decide that a scenario forecast provides a better prediction than an existing baseline forecast, then the scenario forecast may be persisted as the baseline forecast going forward through selection of a set scenario forecast values as overrides indicator, depicted at 1222. For example, the scenario forecast values 1220 could be persisted as the persisted forecast for the Region 1/Product 1 level of a data hierarchy as indicated at 1222.

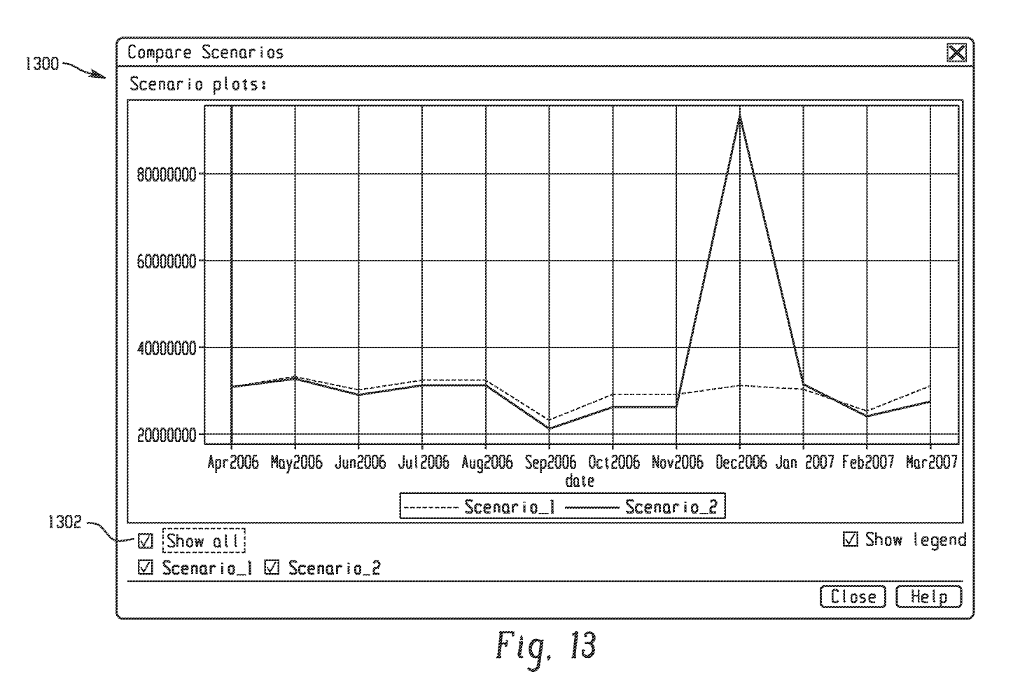

FIG. 13 is a screenshot depicting at 1300 a graphical user interface for displaying a comparison of future values associated with multiple scenarios simultaneously. The scenario display interface 1300 provides a simultaneous comparison among a plurality of scenarios to a user. A user may be able to toggle which of the plurality of scenarios are to be displayed via data controls 1302.

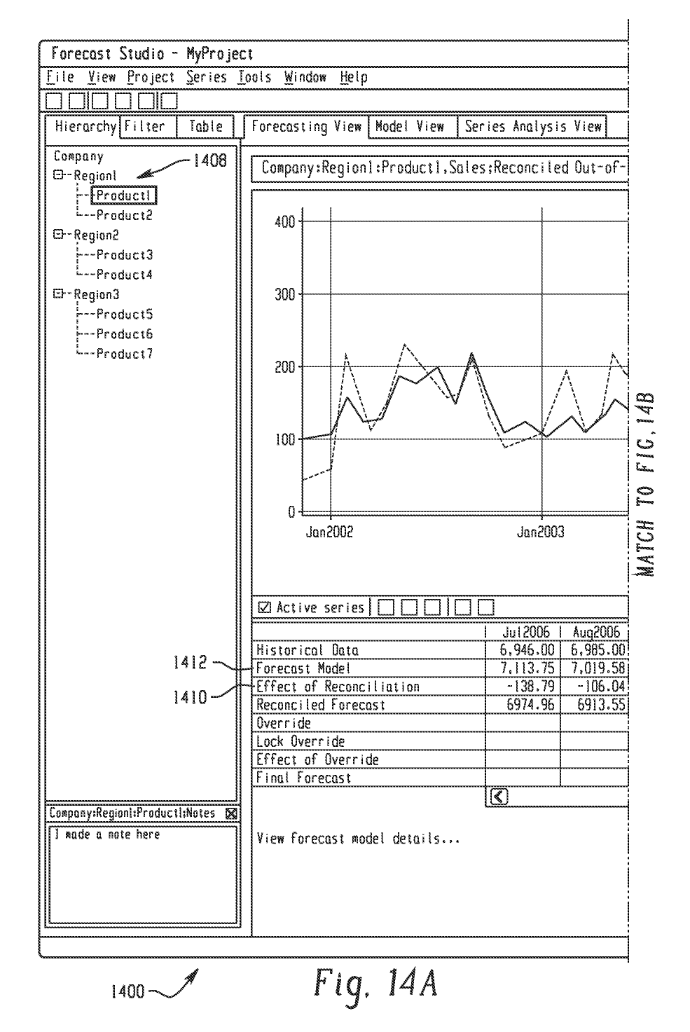

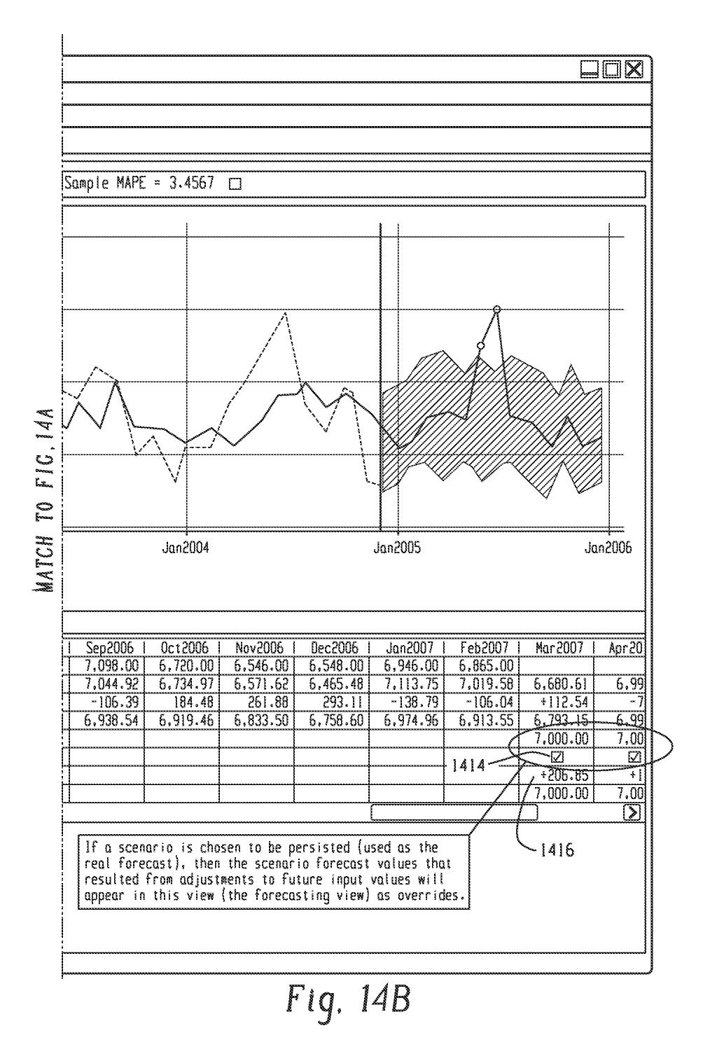

FIGS. 14A and 14B are screenshots depicting at 1400 a graphical user interface for displaying one or more scenarios in comparison with a prior forecast. A forecast display region 1402 provides a graphical depiction of one or more future values of a variable at 1404 as well as past values at 1406. Scenarios may be depicted at a desired level of a data hierarchy as indicated by the hierarchy selection indicators 1408. The user interface 1400 also includes comparison data associated with both the future values of the selected scenario at 1410 and a prior existing forecast at 1412. The forecast display region further offers override selection indicators 1414 and override result data at 1416. The override result data 1416 offers an indication of the effect on the prior existing forecast if the current scenario is selected to replace the prior existing forecast. For example, if the March 2007 scenario value of 7,000 is chosen as an override to the reconciled forecast of 6,793.15, then the effect of the override is 206.85, as indicated at 1416.

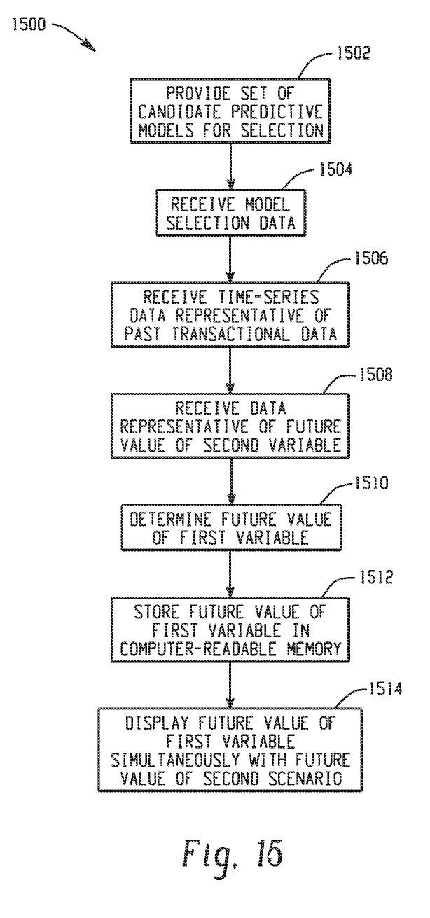

FIG. 15 is a flow diagram depicting at 1500 a computer-implemented method of implementing a scenario analysis manager that performs multiple scenarios based upon time series data that is representative of transactional data and displays results of the multiple scenarios simultaneously. Software instructions can be specially configured to perform the operation in the manner depicted in this figure. At 1502, a set of candidate predictive models is provided for a first scenario for selection where the set of candidate predictive models includes an identification of which variables are associated with a model. Model selection data is received at 1504 where a selected model is configured to predict a future value of a first variable based at least in part on values of a second variable. Time-series data is received at 1506 from a computer-readable memory that represents past transactional activity of the first variable and the second variable, and data representative of a future value of the second variable is received at 1508. At 1510, the future value of the first variable is determined using the selected model, the time-series data, and the future value of the second variable, and the future value of the first variable for the first scenario is stored in a computer-readable memory at 1512. At 1514, the future value of the first variable is displayed simultaneously with a future value of the second scenario.

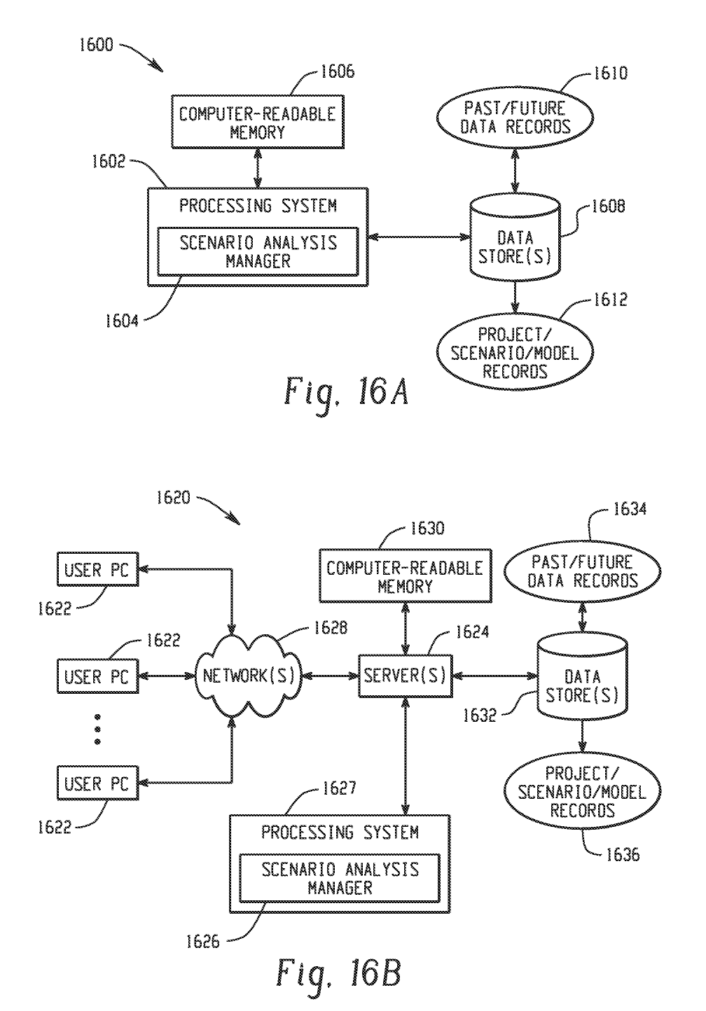

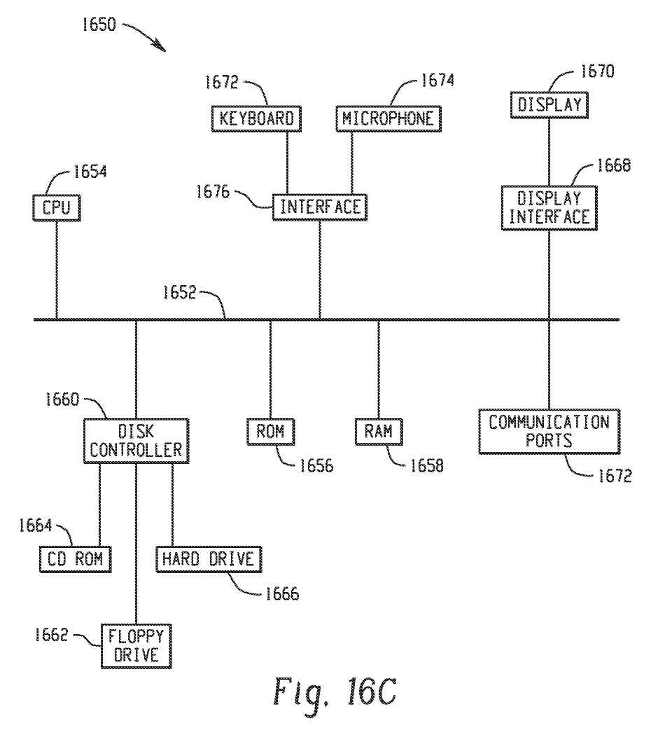

FIGS. 16A, 16B, and 16C depict example systems for use in implementing a scenario analysis manager. For example, FIG. 16A depicts an exemplary system 1600 that includes a stand alone computer architecture where a processing system 1602 (e.g., one or more computer processors) includes a scenario analysis manager 1604 being executed on it. The processing system 1602 has access to a computer-readable memory 1606 in addition to one or more data stores 1608. The one or more data stores 1608 may contain past/future data records 1610 as well as project/scenario/model records 1612.

FIG. 16B depicts a system 1620 that includes a client server architecture. One or more user PCs 1622 accesses one or more servers 1624 running a scenario analysis manager 1626 on a processing system 1627 via one or more networks 1628. The one or more servers 1624 may access a computer readable memory 1630 as well as one or more data stores 1632. The one or more data stores 1632 may contain past/future data records 1634 as well as project/scenario/model records 1636.

FIG. 16C shows a block diagram of exemplary hardware for a stand alone computer architecture 1650, such as the architecture depicted in FIG. 16A, that may be used to contain and/or implement the program instructions of system embodiments of the present invention. A bus 1652 may serve as the information highway interconnecting the other illustrated components of the hardware. A processing system 1654 labeled CPU (central processing unit) (e.g., one or more computer processors), may perform calculations and logic operations required to execute a program. A processor-readable storage medium, such as read only memory (ROM) 1656 and random access memory (RAM) 1658, may be in communication with the processing system 1654 and may contain one or more programming instructions for performing the method of implementing a scenario analysis manager. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 1660 interfaces one or more optional disk drives to the system bus 1652. These disk drives may be external or internal floppy disk drives such as 1662, external or internal CD-ROM, CD-R, CD-RW or DVD drives such as 1664, or external or internal hard drives 1666. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1660, the ROM 1656 and/or the RAM 1658. Preferably, the processor 1654 may access each component as required.

A display interface 1668 may permit information from the bus 1656 to be displayed on a display 1670 in audio, graphic, or alphanumeric format. Communication with external devices may optionally occur using various communication ports 1672.

In addition to the standard computer-type components, the hardware may also include data input devices, such as a keyboard 1672, or other input device 1674, such as a microphone, remote control, pointer, mouse and/or joystick.

U.S. patent application Ser. No. 11/432,127, entitled “Computer-Implemented Systems and Methods for Defining Events,” describes systems and methods for defining events; the entirety of which is herein incorporated by reference. U.S. patent application Ser. No. 11/431,123, entitled “Computer-Implemented Systems and Methods For Storing Data Analysis Models,” describes systems and methods for storing data analysis models; the entirety of which is herein incorporated by reference. U.S. Pat. No. 7,251,589, entitled “Computer-Implemented System and Method For Generating Forecasts,” describes systems and methods for generating forecasts; the entirety of which is herein incorporated by reference.

This written description uses examples to disclose the invention, including the best mode, and also to enable a person skilled in the art to make and use the invention. The patentable scope of the invention may include other examples. For example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

1. (canceled)

2. A computer-program product, tangibly embodied in a machine-readable non-transitory storage medium, including instructions configured to cause a data processing apparatus to perform operations comprising:
storing information depicting multiple forecasting scenarios, wherein each depicted forecasting scenario is associated with multiple models, wherein each of the multiple models is associated with a predictive variable and a forecast variable, and wherein each model is operable to forecast future values for the forecast variable associated with that model;
displaying scenario selection information on a graphical interface by individually depicting each of the stored forecasting scenarios, wherein individually depicting a forecasting scenario includes depicting the models that are associated with that depicted forecasting scenario, and wherein depicting a model includes indicating the predictive variable and the forecast variable associated with that model;
receiving input indicating a selected one of the multiple forecasting scenarios;
receiving a model selection input indicating a selected one of the models associated with the selected forecasting scenario;
receiving inputted variable information, wherein the variable information is used to determine hypothetical future values of the predictive variable associated with the selected model; and
forecasting values of the forecast variable associated with the selected model, wherein forecasting values includes using the selected model and the hypothetical future values of the predictive variable.

3. The computer-program product of claim 2, wherein the inputted variable information indicates a periodic rate of decline, and wherein the hypothetical future values of the predictive variable are characterized by a progressive reduction at the indicated periodic rate.

4. The computer-program product of claim 2, wherein each model is further operable to perform goal-seeking, wherein goal-seeking includes calculating values for the predictive variable associated with the selected model, wherein calculating is based on assumed values of the forecast variable associated with the selected model.

5. The computer-program product of claim 4, wherein the operations further comprise:
receiving goal-seeking information indicating assumed values of the forecast variable associated with the selected model; and
performing a goal-seeking calculation based on the selected model and the assumed values of the forecast variable associated with the selected model, wherein performing the goal-seeking calculation includes determining values of the predictive variable associated with the selected model.

6. The computer-program product of claim 5, wherein the selected model includes a mathematical relationship between the predictive variable associated with the selected model and the forecast variable associated with the selected model.

7. The computer-program product of claim 6, wherein determining values of the predictive variable associated with the model includes using the mathematical relationship.

8. The computer-program product of claim 2, wherein information depicting multiple forecasting scenarios includes information depicting:
a scenario name of one of the multiple scenarios;
a scenario date of creation of one of the multiple scenarios; or
a scenario description of one of the multiple scenarios.

9. The computer-program product of claim 2, wherein the operations further comprise:
for each of the depicted forecasting scenarios individually, storing a name and type of the predictive variable with which the forecasting scenario is associated.

10. The computer-program product of claim 2, wherein the operations further comprise:
storing multiple predictive variable manipulation options;
receiving selection information indicating a selection of one of the multiple predictive variable manipulation options;
altering the hypothetical future values of the predictive variable associated with the selected model, wherein altering is performed based on the selected one of the multiple predictive variable manipulations; and
forecasting updated values of the forecast variable associated with the selected model, wherein forecasting updated values includes using the selected model and the altered hypothetical future values of the predictive variable.

11. The computer-program product of claim 2, wherein each of the models is associated with a quality metric depicting performance of the model when evaluated with holdout data, and wherein the operations further comprise:
displaying a model selection interface, wherein displaying a model selection interface includes:
depicting, with respect to each of the models individually, a name of the model, a type of the model and the quality metric with which the model is associated.

12. The computer-program product of claim 11, wherein displaying a model selection interface further includes:
displaying, with respect to each of the models individually, information about the predictive variable and forecast variable with which the model is associated.

13. The computer-program product of claim 12, wherein further, each of the multiple models is associated with multiple predictive variables.

14. The computer-program product of claim 13, wherein displaying a model selection interface further includes:
displaying, with respect to each of the models individually, a variable sensitivity indication corresponding to that model, wherein a variable sensitivity indication corresponding to a model depicts predictive variables with which that model is both associated with and sensitive to.

15. A system, comprising:
one or more processing units;
one or more non-transitory computer-readable storage mediums containing instructions configured to cause the one or more processing units to perform operations including:
storing information depicting multiple forecasting scenarios, wherein each depicted forecasting scenario is associated with multiple models, wherein each of the multiple models is associated with a predictive variable and a forecast variable, and wherein each model is operable to forecast future values for the forecast variable associated with that model;
displaying scenario selection information on a graphical interface by individually depicting each of the stored forecasting scenarios, wherein individually depicting a forecasting scenario includes depicting the models that are associated with that depicted forecasting scenario, and wherein depicting a model includes indicating the predictive variable and the forecast variable associated with that model;
receiving input indicating a selected one of the multiple forecasting scenarios;
receiving a model selection input indicating a selected one of the models associated with the selected forecasting scenario;
receiving inputted variable information, wherein the variable information is used to determine hypothetical future values of the predictive variable associated with the selected model; and
forecasting values of the forecast variable associated with the selected model, wherein forecasting values includes using the selected model and the hypothetical future values of the predictive variable.

16. The system of claim 15, wherein the inputted variable information indicates a periodic rate of decline, and wherein the hypothetical future values of the predictive variable are characterized by a progressive reduction at the indicated periodic rate.

17. The system of claim 15, wherein each model is further operable to perform goal-seeking, wherein goal-seeking includes calculating values for the predictive variable associated with the selected model, wherein calculating is based on assumed values of the forecast variable associated with the selected model.

18. The system of claim 17, wherein the operations further include:
receiving goal-seeking information indicating assumed values of the forecast variable associated with the selected model;
performing a goal-seeking calculation based on the selected model and the assumed values of the forecast variable associated with the selected model, wherein performing the goal-seeking calculation includes determining values of the predictive variable associated with the selected model.

19. The system of claim 18, wherein the selected model includes a mathematical relationship between the predictive variable associated with the selected model and the forecast variable associated with the selected model.

20. The system of claim 19, wherein determining values of the predictive variable associated with the model includes using the mathematical relationship.

21. The system of claim 15, wherein the information depicting multiple forecasting scenarios includes information depicting:
a scenario name of one of the multiple scenarios;
a scenario date of creation of one of the multiple scenarios; or
a scenario description of one of the multiple scenarios.

22. The system of claim 15, wherein the operations further include:
for each of the depicted forecasting scenarios individually, storing a name and type of the predictive variable with which the forecasting scenario is associated.

23. The system of claim 15, wherein the operations further include:
storing multiple predictive variable manipulation options;
receiving selection information indicating a selection of one of the multiple predictive variable manipulation options;
altering the hypothetical future values of the predictive variable associated with the selected model, wherein altering is performed based on the selected one of the multiple predictive variable manipulations; and
forecasting updated values of the forecast variable associated with the selected model, wherein forecasting updated values includes using the selected model and the altered hypothetical future values of the predictive variable.

24. The system of claim 15, wherein each of the models is associated with a quality metric depicting performance of the model when evaluated with holdout data, wherein the operations further include:
displaying a model selection interface, wherein displaying a model selection interface includes:
depicting, with respect to each of the models individually, a name of the model, a type of the model and the quality metric with which the model is associated.

25. The system of claim 24, wherein displaying a model selection interface further includes:
displaying, with respect to each of the models individually, information about the predictive variable and forecast variable with which the model is associated.

26. The system of claim 25, wherein further, each of the multiple models is associated with multiple predictive variables.

27. The system of claim 26, wherein displaying a model selection interface further includes:
displaying, with respect to each of the models individually, a variable sensitivity indication corresponding to that model, wherein a variable sensitivity indication corresponding to a model depicts predictive variables with which that model is both associated with and sensitive to.

28. A computer-implemented method, comprising:
accessing, on a computing device, information for stored multiple forecasting scenarios, wherein each forecasting scenario is associated with multiple models, wherein each of the multiple models is associated with a predictive variable and a forecast variable, and wherein each model is operable to forecast future values for the forecast variable associated with that model;
displaying scenario selection information on a graphical interface by individually depicting each of the stored forecasting scenarios, wherein individually depicting a forecasting scenario includes depicting the models that are associated with that depicted forecasting scenario, and wherein depicting a model includes indicating the predictive variable and the forecast variable associated with that model;
receiving input for a selection of one of the multiple forecasting scenarios;
receiving a model selection input indicating a selection of one of the models associated with the selected forecasting scenario;
receiving inputted variable information;
determining hypothetical future values of the predictive variable associated with the selected model with the inputted variable information; and
forecasting values of the forecast variable associated with the selected model, wherein forecasting values includes using the selected model and the determined hypothetical future values of the predictive variable.

29. The method of claim 28, wherein the inputted variable information indicates a periodic rate of decline, and wherein the hypothetical future values of the predictive variable are characterized by a progressive reduction at the indicated periodic rate.

30. The method of claim 28, wherein each model is further operable to perform goal-seeking, wherein goal-seeking includes calculating values for the predictive variable associated with the selected model, and wherein calculating is based on assumed values of the forecast variable associated with the selected model.

31. The method of claim 30, further comprising:
receiving goal-seeking information indicating assumed values of the forecast variable associated with the selected model; and
performing a goal-seeking calculation based on the selected model and the assumed values of the forecast variable associated with the selected model, wherein performing the goal-seeking calculation includes calculating values of the predictive variable associated with the selected model.

32. The method of claim 31, wherein the selected model includes a mathematical relationship between the predictive variable associated with the selected model and the forecast variable associated with the selected model.

33. The method of claim 32, wherein calculating values of the predictive variable associated with the model includes using the mathematical relationship.

34. The method of claim 28, wherein information depicting multiple forecasting scenarios includes information depicting:
a scenario name of one of the multiple scenarios;
a scenario date of creation of one of the multiple scenarios; or
a scenario description of one of the multiple scenarios.

35. The method of claim 28, further comprising:
for each of the depicted forecasting scenarios individually, storing a name and type of the predictive variable with which the forecasting scenario is associated.

36. The method of claim 28, further comprising:
storing multiple predictive variable manipulation options;
receiving selection information indicating a selection of one of the multiple predictive variable manipulation options;
altering the hypothetical future values of the predictive variable associated with the selected model, wherein altering is performed based on the selected one of the multiple predictive variable manipulations; and
forecasting updated values of the forecast variable associated with the selected model, wherein forecasting updated values includes using the selected model and the altered hypothetical future values of the predictive variable.

37. The method of claim 28, wherein each of the models is associated with a quality metric depicting performance of the model when evaluated with holdout data, wherein the method further comprises:
displaying a model selection interface, wherein displaying a model selection interface includes:
depicting, with respect to each of the models individually, a name of the model, a type of the model and the quality metric with which the model is associated.

38. The method of claim 37, wherein displaying a model selection interface further includes:
displaying, with respect to each of the models individually, information about the predictive variable and forecast variable with which the model is associated.

39. The method of claim 38, wherein further, each of the multiple models is associated with multiple predictive variables.

40. The method of claim 39, wherein displaying a model selection interface further includes:
displaying, with respect to each of the models individually, a variable sensitivity indication corresponding to that model, wherein a variable sensitivity indication corresponding to a model depicts predictive variables with which that model is both associated with and sensitive to.
